(19) United States
(12) Patent Application Publication
(10) Pub. No.: US 2011/0174134 A1
(43) Pub. Date: Jul. 21, 2011

(54) MUSICAL INSTRUMENT STRING INCLUDING SYNTHETIC SPIDER SILK

(75) Inventors: Eva Mueller-Zierach, Heusenstamm (DE); Volker Mueller-Zierach, Heusenstamm (DE)

(73) Assignee: GUSTAV PIRAZZI & COMP. KG, OFFENBACH (DE)

(21) Appl. No.: 12/377,527

(22) PCT Filed: Aug. 16, 2007
(86) PCT No.: PCT/EP2007/007224

§ 371 Date: Feb. 13, 2009

(30) Foreign Application Priority Data
Aug. 16, 2006 (DE) 10 2006 038 445.8

(51) Int. Cl. G10D 3/10; D02G 3/02

(52) U.S. Cl. 84/297 S; 57/362

(57) ABSTRACT

A method for making a musical instrument string comprises providing a synthetic spider silk and forming the musical instrument string using the silk. A string for a musical instrument comprises a synthetic spider silk.

This application is a U.S. National Phase application under 35 U.S.C. §371 of International Application No. PCT/EP2007/007224, filed on Aug. 16, 2007, which claims priority to German Patent Application No. DE 10 2006 038 445.8, filed on Aug. 16, 2006. The International Application was published in German on Feb. 21, 2008 as WO 2008/019843 under PCT Article 21(2).

The present invention relates to a musical instrument string including synthetic spider silk.

### BACKGROUND

The synthetic production of thread material, whose properties are substantially similar to those of the natural spider silk product, has been perfected over the course of past design developments. A synthetically produced spider silk and a method for the synthetic synthesis thereof are known, for example, from the publications EP 1 287 139 A, EP 1 413 585 A2, EP 1 609 801 A1, WO 2006/002853 A1 and WO 2006/008163 A2. This known synthetically manufactured spider silk is intended for use as thread or as material in the medical sector, for manufacturing mesh or rope, for textile, leather, or paper manufacturing or for use in surface protection. In this context, the synthetic spider silk exhibits especially favorable properties, both in terms of the attainable strength values, as well as the attainable extensibility.

### SUMMARY OF THE PRESENT INVENTION

An aspect of the present invention is to provide an especially advantageous use for a synthetic spider silk of this kind, which will make it possible to utilize its capability to withstand high loads and effectively use its excellent physical properties.

The present invention provides a musical instrument string that includes synthetic spider silk as a component.

Strings for musical instruments are typically manufactured from polymer plastics, animal gut, metal wires, plant fibers and/or animal hair and are generally used in plucked and bowed instruments. Due to the fact that the strings on an instrument are installed under a certain tension and, during use, are hit, plucked or bowed, the musical string is subject to considerable wear. Subsequent tensioning of the musical strings, particularly to tune the musical instrument by adjusting the tension of the string, and the degree of wear lead to crack formations within the string and thus to breakage of the entire string. In addition, the string material used is subject to the effects of aging. It is thus necessary to frequently replace the strings, especially in the case of orchestral instruments, to ensure that the specific musical properties of the instrument, most notably the tonal and acoustical quality, and of the string are not degraded.

A string material having especially durable and strong material properties should be used, particularly in view of the typically high loading of the strings which necessitates that defective strings be replaced relatively frequently. The musical requirements relating specifically to strings should also be met. On the one hand, due to its special molecular structure, a material of this kind should be very extensible, exceptionally loadable, and exhibit high tensile strength; on the other hand, however, its elasticity should conform with the musical specifications. It is advantageous that the string material have good recycling properties. Surprisingly, it has been shown that these material and physical properties are achieved to a very large degree by synthetic spider silk. Moreover, as a string component, synthetic spider silk also has a weight advantage over conventional string materials.

With regard to the intended use, it is expedient when the synthetic spider silk, which has been fabricated as a component of a string, is adapted to specific musical, tonal or acoustic design requirements, and meets elongation resistance and tensile strength requirements of a musical string used for musical instruments, through the proper selection of parameters, for example with respect to dimensioning or composition. A good musical sound, ease of handling during play and, in addition, an especially long useful life are thereby especially attainable.

A high-quality musical string may, in particular, be constructed of a core that is surrounded by a spun covering. The synthetic spider silk may be used for the spun covering. However, in terms of strength and elongation values, the synthetic spider silk has even better properties than Kevlar (aramid fiber) and is thus more suited for playing. Therefore, to utilize its favorable properties, the synthetic spider silk is used very advantageously for a core of musical strings constructed in this manner.

The core of the musical string is preferably formed from a fine thread structure which is provided as a multifilament. The fine threads are preferably manufactured from the synthetically produced spider silk. To produce the multifilament, a multiplicity of thin individual fine threads are twisted to form a “string.” A single- or multi-layer covering of resistant tough material may also be spun around the same. The advantages obtained are greater elasticity and playability. Alternatively, the multifilament may also be provided in a structure in which the fine thread structure is arranged in parallel, and not twisted, in the core.

Strings for musical instruments are differentiated by their technical string construction. Monofilament strings, such as some types of guitar strings, for example, have a relatively thin diameter and are preferably used to produce high-pitched tones. In terms of the attainable strength and elasticity values, the superior properties of the synthetically produced spider silk are advantageous when it comes to monofilament strings having a relatively thin diameter and a single-strand string construction.

In the case of strings for musical instruments having a core, the core may also advantageously have components of synthetically produced spider silk. If the core of the string is fabricated as a high-quality multifilament, as is the case in some types of violin strings, the individual threads, which make up the multifilament, may preferably be made of synthetically produced spider silk. The weight saving resulting therefrom, in particular, and, in addition, the superior physical properties of the synthetically produced spider silk are advantageous in the case of strings whose core has a multifilament.

The use of at least one string, which is manufactured from synthetic spider silk, for musical instruments belonging to the bowed and or plucked instrument family, is advantageously provided.

In accordance with the present invention, a musical instrument, in particular a bowed or a plucked instrument, having a number of musical strings has at least one or a few musical strings that are manufactured using synthetically produced spider silk and/or whose component is synthetically produced spider silk. These strings are advantageously adapted in terms of their acoustic or tonal properties to the intended use as musical strings through the proper selection of parameters, in particular in terms of dimensioning and/or composition.

The advantages attained by the present invention reside, in particular, in that, by using synthetically produced spider silk as a component of a musical string, the requirements for withstanding a high loading and stress, as well as for achieving durability, are met. Thus, the favorable properties of the synthetically produced spider silk, in particular, the comparatively high strength, accompanied by exceptionally high extensibility, may be utilized very beneficially. In addition, in a use of this kind, a weight saving, as well as superior physical properties of the musical string are achieved.

An exemplary embodiment of the present invention is explained in greater detail with reference to a drawing, in which:

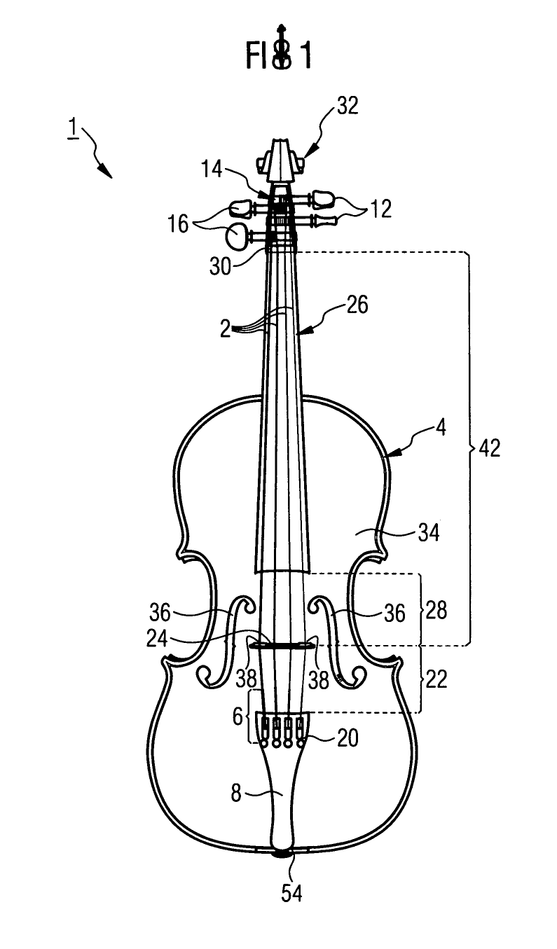

FIG. 1: shows a schematic view of a classical violin;

FIG. 2: shows a musical string for a violin with the bridge, top nut and peg being indicated; and

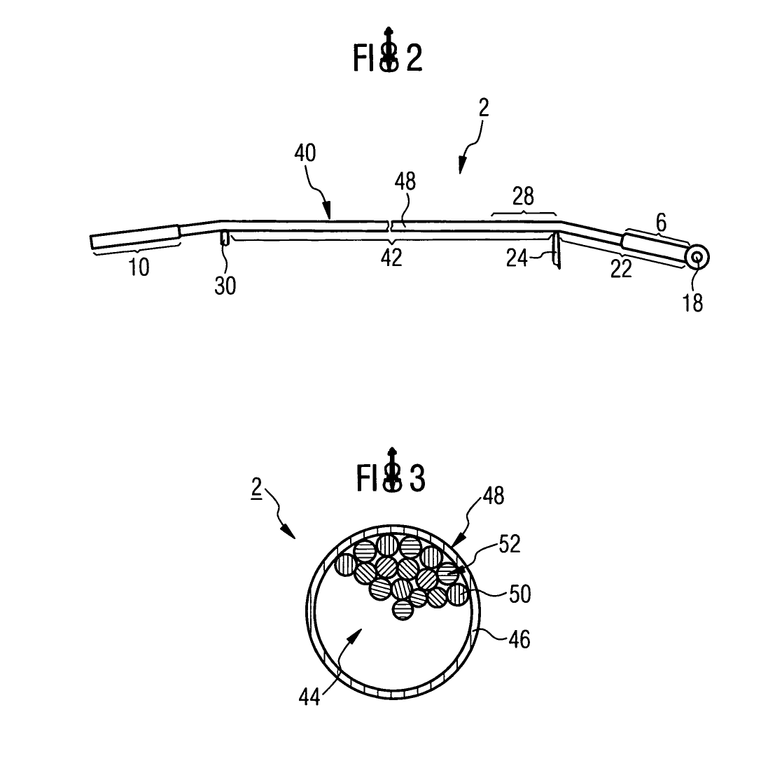

FIG. 3: shows the musical string from FIG. 2 in cross section.

Identical or corresponding parts are provided with the same reference numerals in all of the figures.

A classical violin 1 in accordance with FIG. 1 includes four strings 2 which are stretched over a sound box 4. At a first end, tailpiece end 6, strings 2 are secured to a tailpiece 8. On the other hand, at its second end, peg end 10, they are secured to pegs 12 of a tuning mechanism that is generally referred to as peg box 14. In addition, pegs 12 may have a hole through which peg end 10 of string 2 is threaded. In its attachment region, peg end 10 is wrapped multiple times around peg 12. Pegs 12 are turnable via their peg disks 16, whereby the string tension and thus the tone of string 2 is variable.

At tailpiece end 6, string 2 is provided with a ball end 18 which is secured in tailpiece 8. Also attached to tailpiece 8 is a fine tuner 20 which is used to precisely adjust the tension of each string 2. The musician uses fine tuner 20 to adjust the tone of string 2 even more precisely than is possible using peg 12.

Clamping section 22 of string 2 is disposed between tailpiece 8 and bridge 24 and has colored thread spun on starting at ball end 18 in the region of tailpiece end 6. The purpose of the colored thread is to indicate the string quality. Peg end 10 of string 2 which is wrapped around peg 12 likewise has colored thread spun into the same indicating the precise tonal range of the string to the musician.

The region between bridge 24 and fingerboard 26 is playable region 28 where the musician plucks or bows strings 2. To play the violin, the musician presses on strings 2 along fingerboard 26 to select the various chords and bows strings 2 in playable region 28.

Attached at the other end of fingerboard 26 is a top nut 30 over which strings 2 are routed to pegs 12 in peg box 14. Peg box 14 and, thus, the violin as well terminate in scroll 32.

The two f-holes 36 of the violin are introduced into top plate belly 34 of sound box 4 laterally, at the level of bridge 24. The purpose of f-holes 36 is to allow air enclosed in the sound box to move unhindered, and, in addition, to substantially enhance the vibratory capacity of top plate 34 in the acoustical center around bridge feet 38.

The external structure of string 2 is clarified with reference to FIG. 2. Discernible in this figure are ball end 18 including fixed clamping section 22, which forms tailpiece end 6, and mostly polished string body 40 having attachment peg end 10 of the string, likewise having colored thread spun into the same. Bridge 24 and top nut 30 are indicated in a perspective view. Mostly polished string body 40 is sound-producing section 42 which forms playable region 28 and the region of string 2 above fingerboard 26 up to top nut 30.

FIG. 3 illustrates the internal structure of strings 2 in cross section. The design of string 2 includes a core 44 and a spun covering 46. Spun covering 46, made, for example, of metal or plastic, is mostly polished on its outer sheath 48, depending on the material used. Spun covering 46 is permanently spun around core 44 with up to ten spun-covering layers.

Core 44 contains a multiplicity of essentially parallel extending microfine threads 50 which are made of synthetically produced spider silk and form multifilament 52 of string 2.

Microfine threads 50 in multifilament 52 may be stranded or linked together. However, in the exemplary embodiment, they extend in parallel in a straight direction or are slightly twisted on one side, it being possible for the one-sided twisting to include up to approximately 100 turns per meter of string 2.

With regard to the manufacturing and processing of superfine threads 50, the superior physical properties, the attainable properties in response to compression load and tensile load, the elasticity and tear resistance of the synthetically produced spider silk are utilized. In the same way, when the synthetic spider silk is used as spun covering 46 for string 2, the attainable, superior physical properties of synthetic spider silk are used.

Moreover, string 2, made of multifilament 52 and spun covering 46, which has synthetically produced spider silk as a component, is lighter and has a longer useful life. In addition, a string 2 of this kind has superior playing properties due to its good elongation resistance and tensile strength, and is characterized by ease of handling.

Violin 1 is designed, inter alia, for an especially long lifetime and for a high musical quality of string 2 that is used. To that end, some or all strings 2 are fabricated to include one or a plurality of components of synthetically produced spider silk which are specifically adapted to the requirements of the particular string 2 through the proper selection of parameters, for example composition and thread thickness.

In its end region 54, tailpiece 8 is secured via what is generally referred to as a tail string, under pretensioning, to an end pin. Manufactured spider silk may also be provided as a material component for this tail string.

The use of the spider silk as a musical string is illustrated in the figures based on the example of a string 2 for violin 1 and as string 2 having multifilament 52. It is self-evident that the present invention also includes the use of synthetically produced spider silk as a component of a musical string in any other given stringed instruments, in particular bowed and plucked instruments.

### LIST OF REFERENCE NUMERALS

1 violin

2 string

4 sound box

6 tailpiece end

8 tailpiece

10 peg end

12 peg

14 peg box

16 peg disk

18 ball end

20 fine tuner

22 clamping section

24 bridge

26 fingerboard

28 playable region

30 top nut

32 scroll

34 top plate

36 f-hole

38 bridge feet

40 string body

42 sound-producing section

44 core

46 spun covering

48 outer sheath

50 superfine threads

52 multifilament

54 end region

1-7. (canceled)

8. A method for making a musical instrument string, the method comprising:
providing a synthetic spider silk; and
forming the musical instrument string using the silk.

9. The method as recited in claim 8, further comprising adapting the musical instrument string to a specific musical instrument requirement.

10. The method as recited in claim 8, wherein the forming includes forming at least one thread using the synthetic spider silk.

11. The method as recited in claim 8, wherein the forming includes forming a core from the at least one thread and surrounding the core with a spun covering.

12. The method as recited in claim 11, wherein the forming includes forming a fine thread structure from the at least one thread, and at least one of twisting the fine thread structure so as to form a multifilament and arranging the fine thread structure in parallel so as to form a multifilament.

13. A string for a musical instrument comprising a synthetic spider silk.

14. The string as recited in claim 13, wherein the string has a core and wherein the synthetic spider silk is a component of the core.

15. The string as recited in claim 13, wherein the core is a multifilament including the synthetic spider silk.

16. A musical instrument having at least one string, the string comprising a synthetic spider silk.

17. The musical instrument as recited in claim 16, wherein the musical instrument is a bowed or plucked instrument.

18. The musical instrument as recited in claim 16, wherein the string has a core and wherein the synthetic spider silk is a component of the core.

19. The musical instrument as recited in claim 18, wherein the core includes a multifilament, the multifilament comprising the synthetic spider silk.
